(19) United States
(12) Patent Application Publication
(10) Pub. No.: US 2026/0025824 A1
(43) Pub. Date: Jan. 22, 2026

(54) Repeated Transmission Method, Terminal and Network Side Device

(71) Applicant: VIVO MOBILE COMMUNICATION CO.,LTD., Dongguan (CN)

(72) Inventors: Yitao Mo, Dongguan (CN); Zhipeng Lin, Dongguan (CN); Kun Yang, Dongguan (CN)

(21) Appl. No.: 19/336,899

(22) Filed: Sep. 23, 2025

Related U.S. Application Data
(63) Continuation of application No. PCT/CN2024/082777, filed on Mar. 20, 2024.

(30) Foreign Application Priority Data
Mar. 24, 2023 (CN) 202310302438.4

(51) Int. Cl. H04W 72/21; H04B 7/06

(52) U.S. Cl. CPC H04W 72/21; H04B 7/0626; H04B 7/06966

(57) ABSTRACT

A repetition transmission method includes a terminal determining a target uplink transmission beam. The terminal performs repetition transmission of a target signal based on the target uplink transmission beam, where the target signal includes at least one of a Msg1, an Msg3, an MsgA, a CG-PUSCH, or a SRS.

### CROSS-REFERENCE TO RELATED APPLICATIONS

This application is a Bypass Continuation Application of International Patent Application No. PCT/CN2024/082777 filed Mar. 20, 2024, and claims priority to Chinese Patent Application No. 202310302438.4 filed Mar. 24, 2023, the disclosures of which are hereby incorporated by reference in their entireties.

### BACKGROUND OF THE INVENTION

### Field of the Invention

This application pertains to the field of communication technologies, and in particular relates to a repetition transmission method, a terminal, and a network side device.

### Description of Related Art

In a communication system, user equipment (UE) may perform data transmission during a random access procedure (for example, a 4-step random access procedure (4-step Random Access Channel, 4-step RACH)). That is, UE in a non-connected state (for example, an idle state or an inactive state) may complete data transmission without switching a radio resource control (RRC) state. This type of data transmission during the random access procedure is small data transmission (SDT).

### SUMMARY OF THE INVENTION

According to a first aspect, a repetition transmission method is provided. The method includes: A terminal determines a target uplink transmission beam. The terminal performs repetition transmission of a target signal based on the target uplink transmission beam. The target signal includes at least one of a message Msg1, an Msg3, an MsgA, a configured grant (CG)-physical uplink shared channel (PUSCH), or a sounding reference signal (SRS).

According to a second aspect, a repetition transmission method is provided. The method includes: A network side device sends target indication information. The target indication information includes at least one of the following: first indication information, used to indicate a parameter related to performing uplink transmission beam refinement; second indication information, where the second indication information is used to indicate a transmission mode of an uplink transmission beam, and the transmission mode of the uplink transmission beam includes a first mode in which different uplink transmission beams are indicated to be used in a repetition transmission procedure of a target signal or a second mode in which a same uplink transmission beam is indicated to be used in a repetition transmission procedure of a target signal; or third indication information, where the third indication information is used to indicate a spatial relationship of an uplink transmission beam.

According to a third aspect, a repetition transmission apparatus is provided. The apparatus includes: a determining module, configured to determine a target uplink transmission beam; and an execution module, configured to perform repetition transmission of a target signal based on the target uplink transmission beam. The target signal includes at least one of a message Msg1, an Msg3, an MsgA, a configured grant CG-physical uplink shared channel PUSCH, or a sounding reference signal SRS.

According to a fourth aspect, a repetition transmission apparatus is provided. The apparatus includes: a sending module, configured to send target indication information. The target indication information includes at least one of the following: first indication information, used to indicate a parameter related to performing uplink transmission beam refinement; second indication information, where the second indication information is used to indicate a transmission mode of an uplink transmission beam, and the transmission mode of the uplink transmission beam includes a first mode in which different uplink transmission beams are indicated to be used in a repetition transmission procedure of a target signal or a second mode in which a same uplink transmission beam is indicated to be used in a repetition transmission procedure of a target signal; or third indication information, where the third indication information is used to indicate a spatial relationship of an uplink transmission beam.

According to a fifth aspect, a terminal is provided. The terminal includes a processor and a memory. The memory stores a program or instructions executable on the processor. When the program or the instructions are executed by the processor, the steps of the method according to the first aspect are implemented.

According to a sixth aspect, a terminal is provided. The terminal includes a processor and a communication interface, the communication interface is coupled to the processor, and the processor is configured to run a program or instructions to implement the steps of the method according to the first aspect.

According to a seventh aspect, a network side device is provided. The network side device includes a processor and a memory. The memory stores a program or instructions executable on the processor. When the program or the instructions are executed by the processor, the steps of the method according to the second aspect are implemented.

According to an eighth aspect, a network side device is provided. The network side device includes a processor and a communication interface, the communication interface is coupled to the processor, and the processor is configured to run a program or instructions to implement the steps of the method according to the second aspect.

According to a ninth aspect, a non-transitory readable storage medium is provided. The non-transitory readable storage medium stores a program or instructions. When the program or the instructions are executed by a processor, the steps of the method according to the first aspect are implemented, or the steps of the method according to the second aspect are implemented.

According to a tenth aspect, a wireless communication system is provided. The system includes a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface, the communication interface is coupled to the processor, and the processor is configured to run a program or instructions to implement the method according to the first aspect or the method according to the second aspect.

According to a twelfth aspect, a computer program/program product is provided. The computer program/program product is stored in a non-transitory storage medium, and the program/program product is executed by at least one processor to implement the steps of the method according to the first aspect or the second aspect.

### BRIEF DESCRIPTION OF THE DRAWINGS

FIG. 1 is a schematic diagram of a structure of a wireless communication system according to an example embodiment of this application;

FIG. 2 is a schematic flowchart 1 of a repetition transmission method according to an example embodiment of this application;

FIG. 3 is a schematic flowchart 2 of a repetition transmission method according to an example embodiment of this application;

FIG. 4 is a schematic diagram of a beam refinement process according to an example embodiment of this application;

FIG. 5 is a schematic flowchart 3 of a repetition transmission method according to an example embodiment of this application;

FIG. 6a is a schematic flowchart 4 of a repetition transmission method according to an example embodiment of this application;

FIG. 6b is a schematic diagram of a spatial relationship of an uplink transmission beam in a repetition transmission procedure according to an example embodiment of this application;

FIG. 7a is a schematic diagram 1 of transmission beams in a repetition transmission procedure according to an example embodiment of this application;

FIG. 7b is a schematic diagram 2 of transmission beams in a repetition transmission procedure according to an example embodiment of this application;

FIG. 7c is a schematic diagram 3 of transmission beams in a repetition transmission procedure according to an example embodiment of this application;

FIG. 7d is a schematic diagram 4 of transmission beams in a repetition transmission procedure according to an example embodiment of this application;

FIG. 7e is a schematic diagram 5 of transmission beams in a repetition transmission procedure according to an example embodiment of this application;

FIG. 8 is a schematic flowchart 5 of a repetition transmission method according to an example embodiment of this application;

FIG. 9 is a schematic diagram 1 of a structure of a repetition transmission apparatus according to an example embodiment of this application;

FIG. 10 is a schematic diagram 2 of a structure of a repetition transmission apparatus according to an example embodiment of this application;

FIG. 11 is a schematic diagram of a structure of a terminal according to an example embodiment of this application; and

FIG. 12 is a schematic diagram of a structure of a network side device according to an example embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a number of objects is not limited. For example, there may be one or more first objects. In addition, “or” in this application means at least one of associated objects. For example, “A or B” covers three schemes, namely: scheme 1: including A but not B; scheme 2: including B but not A; and scheme 3: including both A and B. The character “/” generally indicates that associated objects are in an “or” relationship.

It should be noted that technologies described in embodiments of this application are not limited to a long term evolution (LTE)/LTE-advanced (LTE-A) system, and may be applied to other wireless communication systems such as a code division multiple access (CDMA) system, a time division multiple access (TDMA) system, a frequency division multiple access (FDMA) system, an orthogonal frequency division multiple access (OFDMA) system, and a single-carrier frequency division multiple access (SC-FDMA) system. The terms “system” and “network” in the embodiments of this application may be used interchangeably. The technologies described can be applied to both the systems and the radio technologies mentioned above, as well as to other systems and radio technologies. A new radio (NR) system is described in the following descriptions for illustrative purposes, and the NR terminology is used in most of the following descriptions, although these technologies can also be applied to systems other than the NR system, such as a 6th generation (6G) communication system.

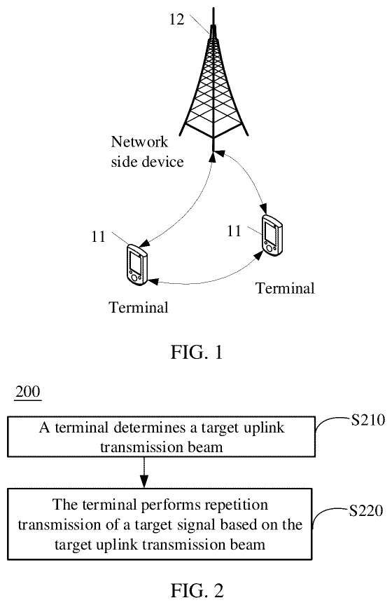

FIG. 1 is a block diagram of a wireless communication system to which embodiments of this application may be applied. The wireless communication system includes a terminal 11 and a network side device 12. The terminal 11 may be a terminal side device, for example, a mobile phone, a tablet computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, a vehicle-mounted device (VUE), shipborne equipment, pedestrian user equipment (PUE), a smart home (a home device with a wireless communication function, for example, a refrigerator, a television, a washing machine, or a furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart anklet, a smart ankle chain, and the like), a smart wristband, smart clothing, and the like. The vehicle-mounted device may also be referred to as a vehicle-mounted terminal, a vehicle-mounted controller, a vehicle-mounted module, a vehicle-mounted component, a vehicle-mounted chip, a vehicle-mounted unit, or the like. It should be noted that a type of the terminal 11 is not limited in the embodiments of this application. The network side device 12 may include an access network device or a core network device, where the access network device may also be referred to as a radio access network (RAN) device, a radio access network function, or a radio access network unit. The access network device may include a base station, a wireless local area network (WLAN) access point (AS), or a wireless fidelity (Wi-Fi) node. The base station may be referred to as a NodeB (NB), an evolved NodeB (eNB), a next generation NodeB (gNB), a new radio NodeB (NR NodeB), an access point, a relay station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the art. As long as the same technical effect is achieved, the base station is not limited to a specified technical term. It should be noted that, in embodiments of this application, only a base station in an NR system is used as an example, and a type of base station is not limited.

How to improve robustness of uplink transmission in procedures such as random access and small data transmission remains a technical problem that urgently needs to be resolved in the art.

The technical solutions provided in embodiments of this application are described in detail below with reference to the accompanying drawings by using some embodiments and application scenarios thereof.

FIG. 2 is a schematic flowchart of a repetition transmission method 200 according to an example embodiment of this application. The method 200 may be performed by a terminal, but is not limited thereto. The method may be performed by hardware and/or software installed in the terminal. In the present embodiment, the method 200 may include at least the following steps. S210: The terminal determines a target uplink transmission beam.

When the terminal determines to perform repetition transmission of a target signal, for example, perform a random access procedure based on repetition transmission of a message (Msg) 1, an Msg3, or an MsgA, a small data transmission procedure based on repetition transmission of a configured grant (CG)-physical uplink shared channel (PUSCH), or a repetition transmission procedure of a sounding reference signal (SRS), to improve robustness of uplink transmission, the terminal may determine (or adjust or scan) the target uplink transmission beam for transmitting the target signal (for example, the Msg1, the Msg3, the MsgA, the CG-PUSCH, or the SRS), and then perform repetition transmission of the target signal based on the target uplink transmission beam.

In addition, in the present embodiment, the terminal may determine the target uplink transmission beam in a plurality of manners. For example, based on different communication requirements, the terminal may determine the target uplink transmission beam based on one or more of the following: a downlink path loss, a measured value of a reference signal, whether a timing advance (TA) of the target signal is valid, whether a plurality of transmission beams indicated to be used in a repetition transmission procedure are the same, and indication information of a network side device (for example, indicating a determining manner of the target uplink transmission beam). This is not limited in the present embodiment.

S220: The terminal performs repetition transmission of the target signal based on the target uplink transmission beam.

Similar to S210, the target signal includes, but is not limited to at least one of the Msg1, the Msg3, the MsgA, the CG-PUSCH, or the SRS.

In the present embodiment, when repetition transmission of the target signal is performed, the terminal determines the target uplink transmission beam, and then performs repetition transmission of the target signal based on the determined target uplink transmission beam. In this way, robustness of uplink transmission can be effectively improved, and transmission performance of a communication system can be guaranteed.

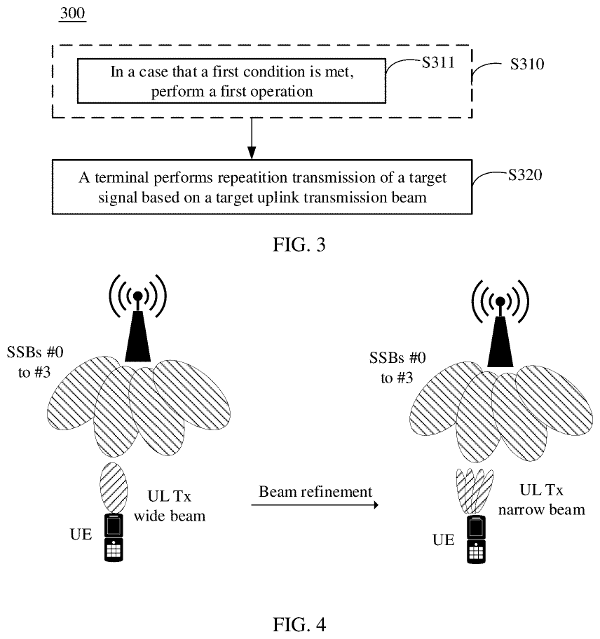

FIG. 3 is a schematic flowchart of a repetition transmission method 300 according to an example embodiment of this application. The method 300 may be performed by a terminal, but is not limited thereto. The method may be performed by hardware and/or software installed in the terminal. In the present embodiment, the method 300 may include at least the following steps.

S310: The terminal determines a target uplink transmission beam.

It may be understood that, for an implementation process of S310, refer to related descriptions in the embodiment of the method 200. In a possible implementation, a process in which the terminal determines the target uplink transmission beam may include S311 shown in FIG. 3. Content is as follows.

S311: In a case that a first condition is met, perform a first operation.

The first condition may be agreed on in a protocol, configured by a higher layer, or autonomously determined by the terminal. In the present embodiment, the first condition may include at least one of the following (11) and (12).

(11) A measured value of at least one first downlink reference signal associated with a first resource for repetition transmission is higher than a first threshold.

The first resource for repetition transmission includes at least one of a resource for contention-free random access (CFRA)-based repetition transmission or a resource for small data transmission based on uplink grant, and the first downlink reference signal may be a synchronization signal block (SSB), a channel state information reference signal (CSI-RS), or the like.

In the present embodiment, the first resource for repetition transmission may be agreed on in a protocol, or may be configured by a network side device (for example, a base station) using higher layer indication information (for example, an RRC message or a system information block (SIB) message) in an explicit, implicit, or another manner.

Correspondingly, the first threshold may be agreed on in a protocol, configured by a higher layer, or autonomously determined by the terminal. For example, the first threshold may be configured in the first resource for repetition transmission. This is not limited herein.

(12) A TA used to send the SRS or the CG-PUSCH is valid.

In this case, the first operation may include the following manner 1 and/or manner 2.

Manner 1: The terminal selects a second downlink reference signal, and determines an uplink transmission beam that matches the second downlink reference signal as the target uplink transmission beam, where the second downlink reference signal is any of at least one first downlink reference signal associated with a first resource for repetition transmission.

For example, assuming that “the measured value of the at least one first downlink reference signal associated with the first resource for repetition transmission is greater than the first threshold” or “the TA used to send the SRS or the CG-PUSCH is valid” in the first condition is met, the terminal selects one of the at least one first downlink reference signal as the second downlink reference signal, and determines the uplink transmission beam that matches the second downlink reference signal as the target uplink transmission beam.

Similar to the first downlink reference signal, the second downlink reference signal may also be an SSB or a CSI-RS. Therefore, in the present embodiment, to improve robustness of uplink transmission, the terminal may use different determining manners of the target uplink transmission beam based on a type of the second downlink reference signal.

For example, in a case that the second downlink reference signal is an SSB, the terminal may perform beam refinement (also referred to as refined beam adjustment) based on the second downlink reference signal to obtain more than one matched uplink transmission beam, and determine the more than one matched uplink transmission beam obtained through beam refinement as the target uplink transmission beam. In the context of this application, “beam refinement” may be understood as follows: Based on a selected downlink reference signal, the terminal performs refined beam adjustment for an uplink transmission beam (UL Tx wide beam) that matches the downlink reference signal, as shown in FIG. 4, to obtain more than one uplink transmission beam (UL Tx narrow beam) that matches the selected downlink reference signal. In this way, uplink transmission beam adjustment is implemented, and accuracy of the uplink transmission beam indicated to be used for repetition transmission of the target signal is guaranteed, thereby improving robustness of uplink transmission.

For another example, in a case that the second downlink reference signal is a CSI-RS, the terminal may determine the uplink transmission beam that matches the second downlink reference signal as the target uplink transmission beam.

Manner 2: The terminal determines an uplink transmission beam that matches a third downlink reference signal as the target uplink transmission beam, where the third downlink reference signal is associated with a second resource for repetition transmission.

The second resource for repetition transmission includes an SRS resource for repetition transmission used for inactive state positioning. In the present embodiment, similar to the first resource for repetition transmission, the second resource for repetition transmission may also be agreed on in a protocol, or may be configured by the network side device (for example, a base station) using higher layer indication information (for example, a radio resource control (RRC) message or a system information block (SIB) message) in an explicit, implicit, or another manner.

Correspondingly, the third downlink reference signal associated with the second resource for repetition transmission may be an SSB, a positioning reference signal (PRS), a CSI-RS, or the like.

In this case, to improve robustness of uplink transmission, the terminal may use different determining manners of the target uplink transmission beam based on a type of the third downlink reference signal. For example, in a case that the third downlink reference signal is an SSB or a PRS, the terminal may perform beam refinement based on the third downlink reference signal to obtain more than one matched uplink transmission beam, and determine the more than one matched uplink transmission beam obtained through beam refinement as the target uplink transmission beam.

It should be noted that a process in which the terminal determines “the more than one matched uplink transmission beam obtained through beam refinement as the target uplink transmission beam” mentioned in the manner 1 and the manner 2 may include: The terminal determines, based on first indication information, the more than one matched uplink transmission beam obtained through beam refinement as the target uplink transmission beam.

The first indication information is used to explicitly or implicitly indicate a parameter related to performing uplink transmission beam refinement. For example, in the present embodiment, the first indication information may be used to indicate at least one of the following (21) to (24).

(21) A total number of different uplink transmission beams indicated to be used in a repetition transmission procedure corresponding to the target signal.

For example, in a case that the first indication information indicates that the total number of different used uplink transmission beams is 4, the terminal may determine four matched uplink transmit narrow beams obtained through beam refinement as the target uplink transmission beam.

(22) An uplink transmission beam indicated to be used for each transmission in the repetition transmission procedure corresponding to the target signal.

For example, in a case that the first indication information indicates that a number of transmissions in the repetition transmission procedure is 2, an uplink transmission beam corresponding to a first CSI-RS having a quasi-orthogonal relationship with the third downlink reference signal is used as an uplink transmission beam in a 1^{st} transmission, and an uplink transmission beam corresponding to a second CSI-RS having a quasi-orthogonal relationship with the third downlink reference signal is used as an uplink transmission beam in a 2^{nd} transmission.

(23) First uplink transmission beam group information, where the first uplink transmission beam group information is used to indicate the uplink transmission beam indicated to be used for each transmission in the repetition transmission procedure corresponding to the target signal.

For example, a first element in a first uplink transmission beam group information indicates that a number of transmissions in the repetition transmission procedure is 2, an uplink transmission beam corresponding to a first CSI-RS having a quasi-orthogonal relationship with the third downlink reference signal is used as an uplink transmission beam in a 1^{st} transmission, and an uplink transmission beam corresponding to a second CSI-RS having a quasi-orthogonal relationship with the third downlink reference signal is used as an uplink transmission beam in a 2^{nd} transmission.

A second element in the first uplink transmission beam group indicates that a number of transmissions in the repetition transmission procedure is 4, an uplink transmission beam corresponding to a first CSI-RS having a quasi-orthogonal relationship with the third downlink reference signal is used as an uplink transmission beam in a 1^{st} transmission, an uplink transmission beam corresponding to a second CSI-RS having a quasi-orthogonal relationship with the third downlink reference signal is used as an uplink transmission beam in a 2^{nd} transmission, an uplink transmission beam corresponding to a third CSI-RS having a quasi-orthogonal relationship with the third downlink reference signal is used as an uplink transmission beam in a 3^{rd} transmission, and an uplink transmission beam corresponding to a fourth CSI-RS having a quasi-orthogonal relationship with the third downlink reference signal is used as an uplink transmission beam in a 4^{th} transmission.

In this case, when determining the target uplink transmission beam, the terminal may determine the target uplink transmission beam based on a number of repetition transmissions of the target signal and the first uplink transmission beam group information. For example, assuming the number of repetition transmissions is 2, the terminal may determine that an uplink transmission beam corresponding to a first CSI-RS having a quasi-orthogonal relationship with the third downlink reference signal is used as a target uplink transmission beam in a 1^{st} transmission of the target signal, and an uplink transmission beam corresponding to a second CSI-RS having a quasi-orthogonal relationship with the third downlink reference signal is used as a target uplink transmission beam in a 2^{nd} transmission of the target signal.

It should be noted that the first uplink transmission beam group may include a plurality of elements other than the first element and the second element, used to indicate different transmissions and corresponding uplink transmission beams in the repetition transmission procedure.

(24) Second uplink transmission beam group information, where the second uplink transmission beam group information is used to indicate a set of uplink transmission beams indicated to be used in the repetition transmission procedure corresponding to the target signal.

For example, a second uplink transmission beam group may indicate that a number of transmissions in the repetition transmission procedure is 4, and the set of used target uplink transmission beams may include an uplink transmission beam corresponding to a first CSI-RS having a quasi-orthogonal relationship with the third downlink reference signal, an uplink transmission beam corresponding to a second CSI-RS having a quasi-orthogonal relationship with the third downlink reference signal, and an uplink transmission beam corresponding to a third CSI-RS having a quasi-orthogonal relationship with the third downlink reference signal.

The terminal may use any uplink transmission beam indicated in the set as the target uplink transmission beam in each transmission in the repetition transmission procedure. For example, the uplink transmission beam corresponding to the third CSI-RS having the quasi-orthogonal relationship with the third downlink reference signal is used as a target uplink transmission beam in a 1^{st} transmission and a 2^{nd} transmission, the uplink transmission beam corresponding to the second CSI-RS having the quasi-orthogonal relationship with the third downlink reference signal is used as a target uplink transmission beam in a 3^{rd} transmission, and the uplink transmission beam corresponding to the first CSI-RS having the quasi-orthogonal relationship with the third downlink reference signal is used as a target uplink transmission beam in a 4^{th} transmission. This is not limited in the present embodiment.

In the present embodiment, the first indication information may be carried in an RRC message, a SIB message, downlink control information (DCI), or the like. This is not limited herein.

Based on this, in a possible implementation, to ensure accuracy of the first indication information sent by the network side device, and improve reliability of a determining result of the target uplink transmission beam, the terminal may report terminal capability information to the network side device before receiving the first indication information, to indicate that the terminal has a capability of scanning an uplink beam in the repetition transmission procedure of the target signal, so that the network side device can determine the first indication information based on the terminal capability information.

Optionally, content of the terminal capability information may include at least one of the following (31) and (32).

(31) A number of uplink transmission beams supported in the repetition transmission procedure, where for example, the terminal supports N (an integer greater than 1) uplink transmission beams in a repetition transmission procedure of the Msg1, the MsgA, the Msg3, the CG-PUSCH, or the SRS.

(32) Uplink transmission beam refinement is supported in the repetition transmission procedure, for example, the terminal supports uplink transmission beam refinement in repetition transmission of the Msg1, the MsgA, the Msg3, the CG-PUSCH, or the SRS.

It should be noted that when determining the first indication information, the network side device may comprehensively consider parameters such as link quality in addition to the terminal capability information, to ensure accuracy of the first indication information.

S320: The terminal performs repetition transmission of the target signal based on the target uplink transmission beam.

The target signal includes at least one of the Msg1, the Msg3, the MsgA, the CG-PUSCH, or the SRS.

It may be understood that, for an implementation process of S320, refer to related descriptions in the embodiment of the method 200. To avoid repetition, details are not described herein again.

In the present embodiment, when performing repetition transmission of the target signal, the terminal determines the target uplink transmission beam by considering the measured value of the reference signal and/or whether the TA of the target signal is valid. In this way, reliability of the determining result of the target uplink transmission beam can be guaranteed, thereby effectively improving robustness of uplink transmission and determining transmission performance of the communication system.

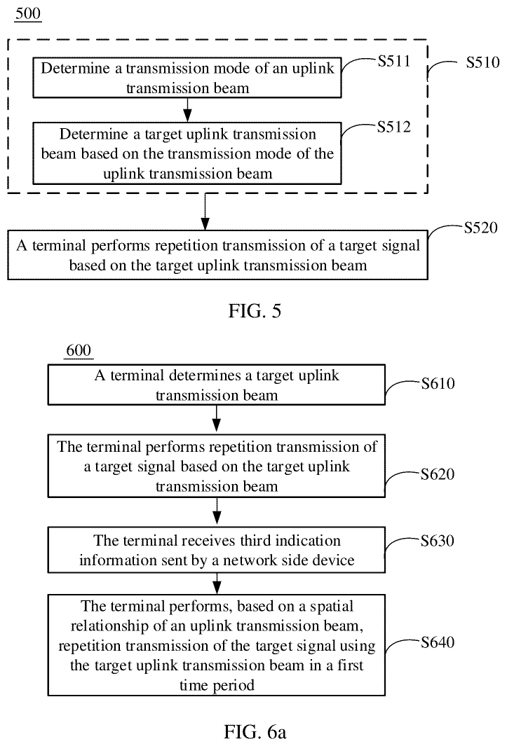

FIG. 5 is a schematic flowchart of a repetition transmission method 500 according to an example embodiment of this application. The method 500 may be performed by a terminal, but is not limited thereto. The method may be performed by hardware and/or software installed in the terminal. In the present embodiment, the method 500 may include at least the following steps. S510: The terminal determines a target uplink transmission beam.

It may be understood that, for an implementation process of S510, refer to related descriptions in the embodiments of the method 200 and the method 300. In a possible implementation, with reference to FIG. 5, a process in which the terminal determines the target uplink transmission beam may include S511 and S512 shown in FIG. 5. Content is as follows. S511: The terminal determines a transmission mode of an uplink transmission beam.

The transmission mode of the uplink transmission beam may include a first mode in which different uplink transmission beams are indicated to be used in a repetition transmission procedure of a target signal or a second mode in which a same uplink transmission beam is indicated to be used in a repetition transmission procedure of a target signal.

In the present embodiment, in the repetition transmission procedure of the target signal, there may be a plurality of determining manners of the transmission mode of the uplink transmission beam. For example, a network side device may explicitly configure the transmission mode of the uplink transmission beam in the repetition transmission procedure of the target signal, or the terminal may determine the transmission mode of the uplink transmission beam based on a measured value of a downlink reference signal, a transmission status of the target signal, or the like. This is not limited herein.

For example, in a possible implementation, in a case that a second condition is met, the terminal may determine that the transmission mode of the uplink transmission beam is the first mode; and in a case that the second condition is not met, the terminal may determine that the transmission mode of the uplink transmission beam is the second mode.

The second condition may include at least one of the following (41) to (44).

(41) The terminal receives second indication information sent by the network side device, and the second indication information indicates that the transmission mode of the uplink transmission beam is the first mode.

The second indication information may be an RRC message, a physical downlink control channel order (PDCCH order), a SIB message, or the like. This is not limited herein.

It may be understood that the second indication information may be determined by the network side device based on capability information, link quality, and the like reported by the terminal. Based on this, in the present embodiment, the second indication information further includes or indicates at least one of the following (a) to (f).

(a) The transmission mode of the uplink transmission beam is the second mode.

It may be understood that, in an implementation, when receiving the second indication information sent by the network side device, and the second indication information indicates that the transmission mode of the uplink transmission beam is the second mode, the terminal may determine that the transmission mode of the uplink transmission beam is the second mode.

(b) A number of repetition transmissions of the target signal. The number of repetition transmissions may be, but is not limited to, an integer multiple of a total number of uplink transmission beams indicated to be used in the repetition transmission procedure.

(c) Resource configuration information used for repetition transmission of the target signal.

The resource configuration information is used to configure a resource for repetition transmission or the like, for example, a resource for repetition transmission in a random access procedure, including but not limited to a random access occasion resource used for repetition transmission of an Msg1 and a preamble resource used for repetition transmission of the Msg1.

(d) A first threshold, used to select a corresponding downlink reference signal in the transmission procedure of the target signal. For example, a measured value of a first downlink reference signal associated with a first resource for repetition transmission is higher than the first threshold. In this case, a downlink reference signal may be selected from the first downlink reference signal to determine the target uplink transmission beam and the like.

(e) A second threshold, where the second threshold is related to a measured value of a downlink path loss and used to determine the transmission mode of the uplink transmission beam. For example, when a downlink path loss value is higher than the second threshold, the transmission mode used for the uplink transmission beam is determined as the first mode. Otherwise, the transmission mode is determined as the second mode.

It should be noted that the “downlink path loss” mentioned in the context of this application may be, but is not limited to, a path loss value corresponding to layer 1 reference signal received power (L1 RSRP) or the like.

(f) A third threshold, where the third threshold is related to the number of repetition transmissions and used to determine the transmission mode of the uplink transmission beam. For example, when the number of repetition transmissions is greater than or equal to the third threshold, the transmission mode used for the uplink transmission beam is determined as the first mode. Otherwise, the transmission mode is determined as the second mode.

It should be noted that, in the present embodiment, in addition to being indicated by the second indication information, the first threshold, the second threshold, and the third threshold may alternatively be agreed on in a protocol, autonomously determined by the terminal, configured in a resource for repetition transmission, or determined in another manner. This is not limited herein.

(42) The measured value of the downlink path loss is less than the second threshold.

(43) Repetition transmission of the target signal is performed based on the second mode, and transmission fails.

For example, when the terminal fails to perform repetition transmission of the target signal based on the second mode in a last transmission, the terminal may determine to determine the target uplink transmission beam based on the first mode when performing repetition transmission of the target signal in a next transmission.

Certainly, when at least one of the following (a) to (e) is met, the terminal may determine or consider that repetition transmission fails.

(a) Random access response reception is considered unsuccessful.

(b) Contention resolution is considered unsuccessful.

(c) A number of preamble transmissions reaches a threshold.

(d) A retransmission timer used for CG-PUSCH transmission is not running, but a CG timer is still running.

(e) A number of CG-PUSCH transmissions reaches a threshold.

(44) The number of repetition transmissions of the target signal is greater than or equal to the third threshold.

It may be understood that when the terminal determines the transmission mode of the uplink transmission beam based on (41) to (44), only one of (41) to (44) may be used for implementation, or two or more of (41) to (44) may be comprehensively considered. This is not limited herein.

S512: The terminal determines the target uplink transmission beam based on the transmission mode of the uplink transmission beam.

The terminal may determine the target uplink transmission beam based only on the transmission mode of the uplink transmission beam, or may determine the target uplink transmission beam comprehensively based on the transmission mode of the uplink transmission beam and the first condition or the like. This is not limited herein.

In this case, for example, assuming that it is determined to perform repetition transmission of a random access procedure based on at least one of the Msg1, an Msg3, or an MsgA, the target uplink transmission beam needs to be determined by comprehensively considering the transmission mode of the uplink transmission beam and the first condition. In addition, the terminal determines, based on the second condition, that the transmission mode of the uplink transmission beam is the first mode (that is, different uplink transmission beams are indicated to be used in the repetition transmission procedure of the target signal), and a measured value of at least one first downlink reference signal associated with the first resource for repetition transmission is not greater than the first threshold (that is, the first condition is not met). Then, when determining the target uplink transmission beam, the terminal may first select any of at least one downlink reference signal associated with a third resource for repetition transmission as a fourth downlink reference signal, and then determine an uplink transmission beam that matches the fourth downlink reference signal as the target uplink transmission beam. The third resource for repetition transmission includes a resource for repetition transmission based on contention-based random access.

Optionally, determining, by the terminal, the uplink transmission beam that matches the fourth downlink reference signal as the target uplink transmission beam includes: in a case that the fourth downlink reference signal is an SSB, performing beam refinement based on the fourth downlink reference signal to obtain more than one matched uplink transmission beam, and determining the more than one matched uplink transmission beam obtained through beam refinement as the target uplink transmission beam.

For another example, assuming that it is determined to perform a repetition transmission procedure based on the CG-PUSCH, the target uplink transmission beam needs to be determined by comprehensively considering the transmission mode of the uplink transmission beam and the first condition. In addition, the terminal determines, based on the second condition, that the transmission mode of the uplink transmission beam is the first mode (that is, different uplink transmission beams are indicated to be used in the repetition transmission procedure of the target signal), and a measured value of at least one first downlink reference signal associated with the first resource for repetition transmission is not greater than the first threshold or a TA used to send the CG-PUSCH is invalid (that is, the first condition is not met). Then, when determining the target uplink transmission beam, the terminal may first select any of the at least one first downlink reference signal associated with the first resource for repetition transmission as a second downlink reference signal, and then determine an uplink transmission beam that matches the second downlink reference signal as the target uplink transmission beam.

For still another example, assuming that it is determined to perform a repetition transmission procedure based on an SRS, the target uplink transmission beam needs to be determined by comprehensively considering the transmission mode of the uplink transmission beam and the first condition. In addition, the terminal determines, based on the second condition, that the transmission mode of the uplink transmission beam is the first mode (that is, different uplink transmission beams are indicated to be used in the repetition transmission procedure of the target signal), and a measured value of at least one first downlink reference signal associated with the first resource for repetition transmission is not greater than the first threshold or a TA used to send the SRS is invalid (that is, the first condition is not met). Alternatively, when determining the target uplink transmission beam, the terminal may first select any of at least one downlink reference signal associated with a second resource for repetition transmission as a third downlink reference signal, and then determine an uplink transmission beam that matches the third downlink reference signal as the target uplink transmission beam. The second resource for repetition transmission includes an SRS resource for repetition transmission used for inactive state positioning.

Optionally, in addition to the foregoing implementation, in another possible implementation, assuming that the transmission mode of the uplink transmission beam is the second mode and the first condition is met (for example, a measured value of at least one first downlink reference signal associated with the first resource for repetition transmission is greater than the first threshold, and a timing advance (TA) used to send an SRS or the CG-PUSCH is valid), the terminal determines the target uplink transmission beam based on the transmission mode of the uplink transmission beam, including the following manner 1 and/or manner 2.

Manner 1: Determine an uplink transmission beam that matches a second downlink reference signal (for example, an SSB or a CSI-RS) as the target uplink transmission beam.

The second downlink reference signal is any of the at least one first downlink reference signal associated with the first resource for repetition transmission, and the first resource for repetition transmission includes at least one of a resource for repetition transmission based on contention-free random access or a resource for small data transmission based on uplink grant.

Manner 2: Determine an uplink transmission beam that matches a third downlink reference signal (for example, an SRS or a PRS) as the target uplink transmission beam.

The third downlink reference signal is associated with a second resource for repetition transmission, and the second resource for repetition transmission includes an SRS resource for repetition transmission used for INACTIVE state positioning.

S520: The terminal performs repetition transmission of the target signal based on the target uplink transmission beam.

The target signal includes at least one of the Msg1, the Msg3, the MsgA, the CG-PUSCH, or the SRS.

It may be understood that, for an implementation process of S520, refer to related descriptions in the embodiments of the method 200 and the method 300. To avoid repetition, details are not described herein again.

In the present embodiment, when performing repetition transmission of the target signal, the terminal first determines the transmission mode of the uplink transmission beam, and determines the target uplink transmission beam based on the transmission mode of the uplink transmission beam. In this way, reliability of a determining result of the target uplink transmission beam can be guaranteed, thereby effectively improving robustness of uplink transmission and determining transmission performance of a communication system.

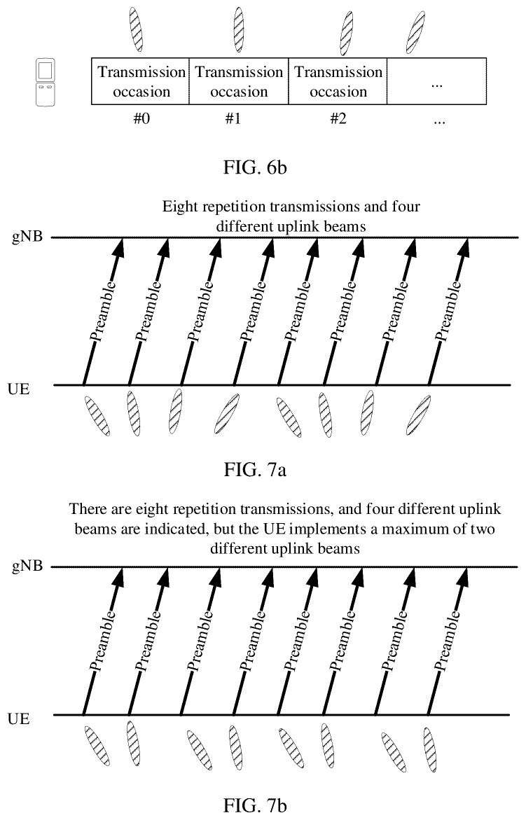

FIG. 6a is a schematic flowchart of a repetition transmission method 600 according to an example embodiment of this application. The method 600 may be performed by a terminal, but is not limited thereto. The method may be performed by hardware and/or software installed in the terminal. In the present embodiment, the method 600 may include at least the following steps.

S610: The terminal determines a target uplink transmission beam.

It may be understood that, for an implementation process of S610, refer to related descriptions in the embodiments of the method 200 to the method 500. Same or corresponding technical effects are achieved. To avoid repetition, details are not described herein again.

S620: The terminal performs repetition transmission of the target signal based on the target uplink transmission beam.

The target signal includes at least one of an Msg1, an Msg3, an MsgA, a CG-PUSCH, or an SRS.

It may be understood that, for an implementation process of S620, refer to related descriptions in the embodiments of the method 200 to the method 500. To avoid repetition, details are not described herein again.

S630: The terminal receives third indication information sent by a network side device.

The third indication information is used to indicate a spatial relationship of an uplink transmission beam, for example, a spatial relationship of an uplink transmission beam indicated to be used after the terminal enters a connected state and before the terminal receives an RRC reconfiguration message, so that the terminal determines, based on the third indication information, the uplink transmission beam indicated to be used after the terminal enters the connected state and before the terminal receives the RRC reconfiguration message. For example, the target uplink transmission beam is indicated to be used. In the present embodiment, the third indication information may be determined by the network side device based on terminal capability information, link quality, and the like reported by the terminal.

In this case, the third indication information may explicitly or implicitly indicate the spatial relationship of the uplink transmission beam. For example, the third indication information may explicitly indicate the spatial relationship of the uplink transmission beam based on at least one of the following (51) to (53).

(51) An index value of a transmission occasion.

For example, an index value of a 1^{st} transmission occasion shown in FIG. 6b is #0. The rest may be deduced by analogy. In this case, a network may send a code point value “00” to indicate that a target uplink transmission beam sent by the terminal at the transmission occasion whose index value is #0 is used as the spatial relationship of the uplink transmission beam.

(52) An index value of a transmission.

For example, assuming that an index value of a 1^{st} transmission (for example, the 1^{st} transmission occasion in FIG. 6b) is #0. The rest may be deduced by analogy. In this case, the network may send a code point value “00” to indicate that a target uplink transmission beam sent by the terminal in the 1^{st} transmission is used as the spatial relationship of the uplink transmission beam.

(53) A radio network temporary identifier (RNTI) associated with the transmission occasion.

For example, an RNTI associated with the 1^{st} transmission occasion shown in FIG. 6b is an RNTI 1. The rest may be deduced by analogy. In this case, the network may send downlink response scheduling information scrambled by the RNTI 1. When detecting the downlink response scheduling information scrambled by the RNTI 1, the terminal uses a target uplink transmission beam sent at the 1^{st} transmission occasion as the spatial relationship of the uplink transmission beam.

Optionally, the third indication information may be carried in an RRC message, a medium access control control element (MAC CE), a random access response (RAR), or the like. In addition, the third indication information may be further used to indicate a transmission manner of a reconfigured spatial relationship of an uplink transmission beam, such as transmission using a MAC CE. This is not limited herein.

S640: The terminal performs, based on the spatial relationship of the uplink transmission beam, repetition transmission of the target signal using the target uplink transmission beam in a first time period.

In addition to the Msg1, the Msg3, the MsgA, the CG-PUSCH, and the SRS described in the embodiments of the method 200 to the method 500, the target signal further includes other subsequent uplink data and the like, for example, uplink data whose sending occasion is after a sending occasion of the target signal. This is not limited herein.

The first time period is a time period between the terminal receives the third indication information and the terminal receives configuration information of the spatial relationship of the uplink transmission beam again, that is, time after the terminal enters the connected state and before the terminal receives the RRC reconfiguration message. In other words, the terminal performs, based on the third indication information, repetition transmission of the target signal using the target uplink transmission beam within the time after the terminal receives the third indication information and before the terminal receives the configuration information of the spatial relationship of the uplink transmission beam again. In this way, an indication of validity time of the target uplink transmission beam is indicated by the third indication information, so that validity of the target uplink transmission beam can be guaranteed, thereby ensuring transmission validity of the target signal.

In addition, in a possible implementation, in addition to indicating the spatial relationship of the uplink transmission beam, the third indication information may be further used to indicate validity duration of the spatial relationship of the uplink transmission beam, a number of times of valid uplink sending corresponding to the spatial relationship of the uplink transmission beam, or the like.

In this case, when transmitting the target signal, within the validity duration or the number of times of valid uplink sending, the terminal may send the target signal using the target uplink transmission beam;

and/or within the validity duration or the number of times of valid uplink sending, and in a case that a change amplitude of a measured value of a downlink path loss (for example, L1-RSRP) is less than a cell configuration threshold, the terminal sends the target signal based on the target uplink transmission beam.

In other words, within the number of times of valid uplink sending and/or the validity duration corresponding to the spatial relationship of the uplink transmission beam, the terminal sends the target signal based on the target uplink transmission beam. In this way, validity of the target uplink transmission beam can be guaranteed, thereby ensuring transmission validity of the target signal.

In the present embodiment, the terminal determines the target uplink transmission beam and receives the third indication information used to indicate the spatial relationship of the uplink transmission beam, and then performs, based on the spatial relationship of the uplink transmission beam, repetition transmission of the target signal using the target uplink transmission beam within the first time period. In this way, the validity duration of the target uplink transmission beam can be determined, thereby ensuring reliability of transmission of the target signal.

Based on descriptions of repetition transmission methods provided in the embodiments of the method 200 to the method 600, the repetition transmission procedure provided in this application is further described below with reference to different examples. Content is as follows.

### Example 1

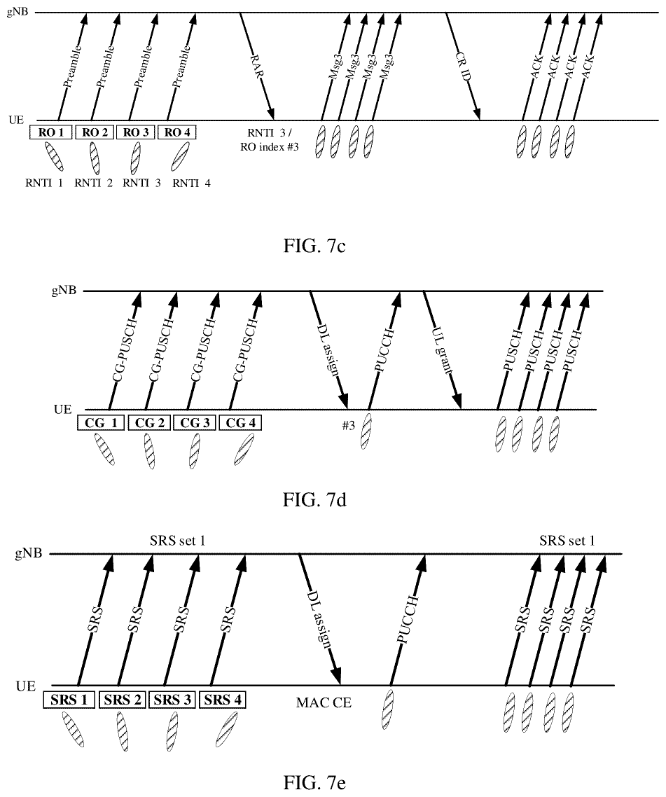

It is assumed that the target signal is the Msg1, and it is determined based on the second condition that different uplink transmission beams are indicated to be used in a random access procedure of repetition transmission of the Msg1, that is, the first mode is used. In addition, as shown in FIG. 7a, the number (8) of repetition transmissions is an integer multiple of the number (4) of uplink transmission beams. In this case, the repetition transmission procedure is as follows.

(a) In a case that the terminal (UE) determines that repetition transmission of the Msg1 is applicable to the current random access procedure, and a measured value of at least one beam in one or more first downlink reference signals (for example, an SSB) indicated in a random access resource corresponding to a contention-free random access procedure configured by the network side device (gNB) is higher than the first threshold, the UE selects a downlink reference signal (that is, a second downlink reference signal) from the one or more first downlink reference signals, determines an uplink transmission beam that matches the second downlink reference signal as the target uplink transmission beam, and performs eight repetition transmissions of the Msg1 based on the target uplink transmission beam. “Preamble” shown in FIG. 7a is a preamble.

For example, in a case that a MAC layer of the UE indicates a physical (PHY) layer to use different uplink transmission beams (the uplink transmission beams have a spatial pairing relationship with the selected downlink reference signal) and that a total number of configured uplink transmission beams is M, that is, 4 as shown in FIG. 7a, the physical layer of the UE uses four uplink transmission beams to repeatedly transmit and send the Msg1. A number of times of repetition transmission and sending is greater than or equal to M. For example, in a case that the number of repetition transmissions is an integer multiple of the number of uplink transmission beams indicated to be used for sending, integer-multiple (number of repetitions/M) rounds of repeated sending are sequentially performed. In each round of repeated sending, transmission is performed using the M different uplink transmission beams (a sequence in which the M different uplink transmission beams are indicated to be used for sending depends on an implementation, but the sequence in which the transmission beams are indicated to be used for sending remains unchanged in each round, that is, a sequence in a 1^{st} round is used).

Alternatively, as shown in FIG. 7b, in a case that the physical layer of the UE uses M (for example, 4) target uplink transmission beams to repeatedly transmit and send the Msg1, where a number (for example, 8) of times of repetition transmission and sending is greater than or equal to M, and a value of M exceeds a maximum number (for example, 2) of uplink beams supported by the UE, the UE repeatedly transmits and sends the Msg1 based on the maximum number (for example, 2) of supported uplink transmission beams (in this case, in each round of repetition transmission procedure of the Msg1, the UE uses one or more different uplink transmission beams to repeatedly transmit the Msg1).

(b) After the UE performs repetition transmission of the Msg1, the UE receives an RAR sent by the gNB, and determines, based on a random access resource location corresponding to an RNTI scheduled by the received RAR, a beam indicated to be used for subsequent uplink sending. As shown in FIG. 7c, in a case that the UE receives a matched RNTI 3 and performs transmission using a different uplink transmission beam, the UE determines to use an uplink transmission beam corresponding to an RO 3 as a beam indicated to be used for subsequent uplink sending, and the MAC layer of the UE indicates the determined target uplink transmission beam to the PHY layer. For example, when subsequently sending PUCCH-ACKs corresponding to an Msg3 and an Msg4, the UE uses the uplink beam for uplink repetition transmission. In a case that contention resolution is unsuccessful, the UE may reselect a downlink reference signal to determine the target uplink transmission beam, and use a different target uplink transmission beam for repetition transmission of the Msg1.

Alternatively, as shown in FIG. 7c, after the UE performs repetition transmission of the Msg1, in a case that the UE receives an RAR, the UE determines, based on an index value of a transmission occasion scheduled by the received RAR, a beam indicated to be used for subsequent uplink sending. For example, in a case that the UE receives a matched RNTI 3, an RO 3 is indicated in the corresponding RAR, and the UE performs transmission using a different uplink transmission beam, the UE determines to use an uplink transmission beam corresponding to the RO 3 as the beam indicated to be used for subsequent uplink sending.

### Example 2

It is assumed that the target signal is the CG-PUSCH, that is, repetition transmission in a small data transmission procedure is performed based on the CG-PUSCH, and a gNB is configured with a CG-PUSCH resource, that is, the first resource for repetition transmission. In addition, UE determines, based on the second condition, that the transmission mode of the uplink transmission beam is the first mode (in other words, repetition transmission is performed by using different uplink transmission beams). In this case, the repetition transmission procedure is as follows.

In a case that an uplink grant-based small data transmission procedure is triggered and in progress, and the UE selects a second downlink reference signal, and in a case that the measured value of the downlink path loss is less than the second threshold, repetition transmission of the CG-PUSCH is used for uplink transmission carrying a common control channel (CCCH) message. A MAC layer of the UE indicates a PHY layer to use different uplink transmission beams and that the number of uplink transmission beams indicated to be used for sending is M (4 as shown in FIG. 7d). For a CG bundle, the physical layer of the UE may use M uplink transmission beams for CG-PUSCH repetition transmission. In addition, in this case, the UE records a first measured value of the downlink reference signal.

After CG-PUSCH repetition transmission is performed, the gNB may indicate an index value of a transmission through downlink scheduling (for example, using the third indication information carried in the MAC CE). The UE determines, based on the index value, a beam indicated to be used for subsequent uplink sending. For example, as shown in FIG. 7d, in a case that the UE receives an index value #3, the UE determines to use an uplink transmission beam corresponding to a CG 3 as the beam indicated to be used for subsequent uplink sending.

In a case that a next downlink reference signal selected by the UE is the same as the previously selected downlink reference signal, and it is recorded that a change amplitude between a second measured value and the first measured value (an absolute value of a difference between the second measured value and the first measured value) corresponding to the downlink reference signal in this case is less than the cell configuration threshold, the UE continues to use the uplink transmission beam corresponding to the CG 3 as a beam indicated to be used for subsequent uplink sending, and ignores index value indication information sent by the network. Otherwise, the previous step is performed.

### Example 3

It is assumed that the target signal is the CG-PUSCH, that is, repetition transmission in a small data transmission procedure is performed based on the CG-PUSCH, and a gNB is configured with a CG-PUSCH resource, that is, the first resource for repetition transmission. In addition, UE determines, based on that the second condition is not met, that the transmission mode of the uplink transmission beam is the second mode (in other words, repetition transmission is performed by using a same uplink transmission beam). In this case, the repetition transmission procedure is as follows.

In a case that an uplink grant-based small data transmission procedure is triggered and in progress, and the UE selects a second downlink reference signal, and in a case that the measured value of the downlink path loss is greater than the second threshold, repetition transmission of the CG-PUSCH is used for uplink transmission carrying a common control channel (CCCH) message. A MAC layer of the UE indicates a PHY layer to use a same uplink transmission beam and that the number of uplink transmission beams indicated to be used for sending is M (4 as shown in FIG. 7d). For a CG bundle, the physical layer of the UE may use M uplink transmission beams for CG-PUSCH repetition transmission.

After CG-PUSCH repetition transmission is performed, in a case that a network side does not have all scheduling information (downlink scheduling information or uplink scheduling information) sent by the gNB, and a CG-PUSCH timer is not running but a CG timer is running, the UE may consider that the current repetition transmission fails. When performing CG-PUSCH repetition transmission again, the UE may determine that the transmission mode of the uplink transmission beam is the first mode (that is, repetition transmission is performed by using different uplink transmission beams).

### Example 4

It is assumed that the target signal is the SRS, that is, repetition transmission based on an SRS procedure is performed, and the network side device is configured with an SRS resource for repetition transmissions, that is, the second resource for repetition transmission. In this case, the repetition transmission procedure is as follows.

When an SRS signal configuration used for INACTIVE state positioning is configured (when receiving the configuration, UE measures a downlink path loss reference and records a corresponding first measured value). In a case that an uplink spatial relationship corresponding to the SRS resource for repetition transmission configured by the NW is associated with an SSB/PRS reference signal (that is, the third downlink reference signal), and in a case that the measured value of the downlink path loss is less than the second threshold, different uplink transmission beams are indicated to be used, that is, the first mode is sued, and the target uplink transmission beam is determined based on the third downlink reference signal.

In addition, a MAC layer indicates a PHY layer to use different uplink transmission beams and that the number of configured uplink transmission beams is M. For an SRS set, the physical layer of the UE uses M uplink beams for SRS repetition transmission and sending. In addition, in this case, the UE records the first measured value corresponding to the downlink path loss.

After SRS repetition transmission performed, a gNB may indicate an index value of a transmission or an index value of a transmission occasion through downlink scheduling (for example, using the third indication information carried in the MAC CE). The UE determines, based on the index value, a beam indicated to be used for subsequent uplink sending. For example, as shown in FIG. 7e, in a case that the UE receives an index value #3, the UE determines to use an uplink transmission beam corresponding to an SRS 3 as the beam indicated to be used for subsequent uplink sending. For example, in a case that the UE measures a second measured value corresponding to the downlink path loss in a next transmission occasion set of the SRS set, and a change amplitude between the second measured value and the previously recorded first measured value (an absolute value of a difference between the second measured value and the first measured value) is less than the cell configuration threshold, the UE continues to use the uplink transmission beam corresponding to the SRS 3 as a beam indicated to be used for subsequent uplink sending.

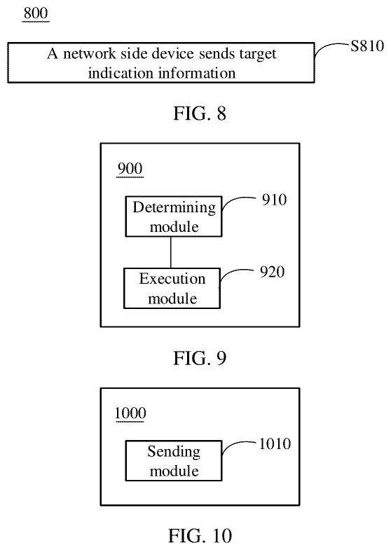

FIG. 8 is a schematic flowchart of a repetition transmission method 800 according to an example embodiment of this application. The method 800 may be performed by a network side device, but is not limited thereto. The method may be performed by hardware and/or software installed in the network side device. In the present embodiment, the method 800 may include at least the following step.

S810: The network side device sends target indication information.

The target indication information includes at least one of the following: first indication information, used to indicate a parameter related to performing uplink transmission beam refinement; second indication information, where the second indication information is used to indicate a transmission mode of an uplink transmission beam, and the transmission mode of the uplink transmission beam includes a first mode in which different uplink transmission beams are indicated to be used in a repetition transmission procedure of a target signal or a second mode in which a same uplink transmission beam is indicated to be used in a repetition transmission procedure of a target signal; or third indication information, where the third indication information is used to indicate a spatial relationship of an uplink transmission beam.

Optionally, the first indication information is used to indicate at least one of the following: a total number of different uplink transmission beams indicated to be used in the repetition transmission procedure corresponding to the target signal; an uplink transmission beam indicated to be used for each transmission in the repetition transmission procedure corresponding to the target signal; first uplink transmission beam group information, where the first uplink transmission beam group information is used to indicate the uplink transmission beam indicated to be used for each transmission in the repetition transmission procedure corresponding to the target signal; or second uplink transmission beam group information, where the second uplink transmission beam group information is used to indicate a set of uplink transmission beams indicated to be used in the repetition transmission procedure corresponding to the target signal.

Optionally, the second indication information includes at least one of the following: that the transmission mode of the uplink transmission beam is the first mode; that the transmission mode of the uplink transmission beam is the second mode; a number of repetition transmissions of the target signal; resource configuration information used for repetition transmission of the target signal; a first threshold, used to select a corresponding downlink reference signal in the transmission procedure of the target signal; a second threshold, where the second threshold is related to a measured value of a downlink path loss and used to determine the transmission mode of the uplink transmission beam; or a third threshold, where the third threshold is related to the number of repetition transmissions and used to determine the transmission mode of the uplink transmission beam.

Optionally, the third indication information is further used to indicate at least one of the following: validity duration of the spatial relationship of the uplink transmission beam; or a number of times of valid uplink sending corresponding to the spatial relationship of the uplink transmission beam.

It may be understood that the embodiment of the method 800 has same or corresponding technical features as the embodiments of the method 200 to the method 700. Therefore, for related descriptions of the embodiment of the method 800, refer to related descriptions in the embodiments of the method 200 to the method 700. Same or corresponding technical effects are achieved. To avoid repetition, details are not described herein again.

The repetition transmission method provided in embodiments of this application may be performed by a repetition transmission apparatus. In embodiments of this application, an example in which the repetition transmission apparatus performs the repetition transmission method is used to describe the repetition transmission apparatus provided in embodiments of this application.

FIG. 9 is a schematic diagram of a structure of a repetition transmission apparatus 900 according to an embodiment of this application. The apparatus 900 includes: a determining module 910, configured to determine a target uplink transmission beam; and an execution module 920, configured to perform repetition transmission of a target signal based on the target uplink transmission beam. The target signal includes at least one of an Msg1, an Msg3, an MsgA, a CG-PUSCH, or an SRS.

Optionally, determining, by the determining module 910, the target uplink transmission beam includes: in a case that a first condition is met, performing at least one of the following: selecting a second downlink reference signal, and determining an uplink transmission beam that matches the second downlink reference signal as the target uplink transmission beam, where the second downlink reference signal is any of at least one first downlink reference signal associated with a first resource for repetition transmission; or determining an uplink transmission beam that matches a third downlink reference signal as the target uplink transmission beam, where the third downlink reference signal is associated with a second resource for repetition transmission, where the first resource for repetition transmission includes at least one of a resource for repetition transmission based on contention-free random access or a resource for small data transmission based on uplink grant, and the second resource for repetition transmission includes an SRS resource for repetition transmission used for inactive state positioning; and the first condition includes at least one of the following that: a measured value of the at least one first downlink reference signal associated with the first resource for repetition transmission is higher than a first threshold; or a timing advance TA used to send the SRS or the CG-PUSCH is valid.

Optionally, determining, by the determining module 910, the uplink transmission beam that matches the second downlink reference signal as the target uplink transmission beam includes at least one of the following: in a case that the second downlink reference signal is a synchronization signal block SSB, performing beam refinement based on the second downlink reference signal to obtain more than one matched uplink transmission beam, and determining the more than one matched uplink transmission beam obtained through beam refinement as the target uplink transmission beam; or in a case that the second downlink reference signal is a channel state information reference signal CSI-RS, determining the uplink transmission beam that matches the second downlink reference signal as the target uplink transmission beam.

Optionally, determining, by the determining module 910, the uplink transmission beam that matches the third downlink reference signal as the target uplink transmission beam includes: in a case that the third downlink reference signal is an SSB or a positioning reference signal PRS, performing beam refinement based on the third downlink reference signal to obtain more than one matched uplink transmission beam, and determining the more than one matched uplink transmission beam obtained through beam refinement as the target uplink transmission beam.

Optionally, determining, by the determining module 910, the more than one matched uplink transmission beam obtained through beam refinement as the target uplink transmission beam includes: determining, based on first indication information, the more than one matched uplink transmission beam obtained through beam refinement as the target uplink transmission beam, where the first indication information is used to indicate at least one of the following: a total number of different uplink transmission beams indicated to be used in a repetition transmission procedure corresponding to the target signal; an uplink transmission beam indicated to be used for each transmission in the repetition transmission procedure corresponding to the target signal; first uplink transmission beam group information, where the first uplink transmission beam group information is used to indicate the uplink transmission beam indicated to be used for each transmission in the repetition transmission procedure corresponding to the target signal; or second uplink transmission beam group information, where the second uplink transmission beam group information is used to indicate a set of uplink transmission beams indicated to be used in the repetition transmission procedure corresponding to the target signal.

Optionally, determining, by the determining module 910, the target uplink transmission beam includes: determining a transmission mode of an uplink transmission beam; and determining the target uplink transmission beam based on the transmission mode of the uplink transmission beam, where the transmission mode of the uplink transmission beam includes a first mode in which different uplink transmission beams are indicated to be used in the repetition transmission procedure of the target signal or a second mode in which a same uplink transmission beam is indicated to be used in the repetition transmission procedure of the target signal.

Optionally, determining, by the determining module 910, the transmission mode of the uplink transmission beam includes: in a case that a second condition is met, determining that the transmission mode of the uplink transmission beam is the first mode, where the second condition includes at least one of the following that: second indication information sent by a network side device is received, and the second indication information indicates that the transmission mode of the uplink transmission beam is the first mode; a measured value of a downlink path loss is less than a second threshold; repetition transmission of the target signal is performed based on the second mode, and transmission fails; or a number of repetition transmissions of the target signal is greater than or equal to a third threshold.

Optionally, before the determining module 910 determines the target uplink transmission beam based on the transmission mode of the uplink transmission beam, determining the target uplink transmission beam further includes: in a case that the second condition is not met, determining, by the terminal, that the transmission mode of the uplink transmission beam is the second mode.

Optionally, the second indication information further includes or indicates at least one of the following: that the transmission mode of the uplink transmission beam is the second mode; the number of repetition transmissions of the target signal; resource configuration information used for repetition transmission of the target signal; the first threshold, used to select a corresponding downlink reference signal in the transmission procedure of the target signal; the second threshold, where the second threshold is related to the measured value of the downlink path loss and used to determine the transmission mode of the uplink transmission beam; or the third threshold, where the third threshold is related to the number of repetition transmissions and used to determine the transmission mode of the uplink transmission beam.

Optionally, in a case that the transmission mode of the uplink transmission beam is the first mode and the first condition is not met, determining, by the determining module 910, the target uplink transmission beam based on the transmission mode of the uplink transmission beam includes: selecting a fourth downlink reference signal, and determining an uplink transmission beam that matches the fourth downlink reference signal as the target uplink transmission beam, where the fourth downlink reference signal is any of at least one downlink reference signal associated with a third resource for repetition transmission, where the third resource for repetition transmission includes a resource for repetition transmission based on contention-based random access, repetition transmission of the target signal is applicable to a random access procedure, and the target signal includes at least one of the Msg1, the Msg3, or the MsgA. A third condition includes at least one of the following: a measured value of the at least one downlink reference signal associated with the third resource for repetition transmission is higher than the first threshold.

Optionally, determining, by the determining module 910, the uplink transmission beam that matches the fourth downlink reference signal as the target uplink transmission beam includes: in a case that the fourth downlink reference signal is an SSB, performing beam refinement based on the fourth downlink reference signal to obtain more than one matched uplink transmission beam, and determining the more than one matched uplink transmission beam obtained through beam refinement as the target uplink transmission beam.

Optionally, in a case that the transmission mode of the uplink transmission beam is the second mode and the first condition is met, determining, by the determining module 910, the target uplink transmission beam based on the transmission mode of the uplink transmission beam includes at least one of the following: determining the uplink transmission beam that matches the second downlink reference signal as the target uplink transmission beam; or determining the uplink transmission beam that matches the third downlink reference signal as the target uplink transmission beam.

Optionally, the execution module 920 is further configured to: receive third indication information sent by the network side device, where the third indication information is used to indicate a spatial relationship of an uplink transmission beam; and perform, based on the spatial relationship of the uplink transmission beam, repetition transmission of the target signal using the target uplink transmission beam in a first time period, where the first time period is a time period between the terminal receives the third indication information and the terminal receives configuration information of the spatial relationship of the uplink transmission beam again.

Optionally, the third indication information is further used to indicate at least one of the following: validity duration of the spatial relationship of the uplink transmission beam; or a number of times of valid uplink sending corresponding to the spatial relationship of the uplink transmission beam.

Optionally, performing, by the execution module 920 based on the spatial relationship of the uplink transmission beam, sending using the target uplink beam in the first time period includes at least one of the following: within the validity duration or the number of times of valid uplink sending, sending the target signal using the target uplink transmission beam; or within the validity duration or the number of times of valid uplink sending, and in a case that a change amplitude of the measured value of the downlink path loss is less than a cell configuration threshold, sending the target signal based on the target uplink transmission beam.

Optionally, the spatial relationship of the uplink transmission beam is determined based on at least one of the following: an index value of a transmission occasion; an index value of a transmission; or a radio network temporary identifier RNTI associated with the transmission occasion.

Optionally, the execution module 920 is further configured to report terminal capability information to the network side device, where the terminal capability information is used to indicate that the terminal has a capability of scanning an uplink beam in the repetition transmission procedure of the target signal.

Optionally, content of the terminal capability information includes at least one of the following: a number of uplink transmission beams supported in the repetition transmission procedure; or uplink transmission beam refinement is supported in the repetition transmission procedure.

The repetition transmission apparatus 900 in the present embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not limited in the present embodiment of this application.

The repetition transmission apparatus 900 provided in the present embodiment of this application can implement the processes implemented in the method embodiments of FIG. 2 to FIG. 6, and achieve same technical effects. To avoid repetition, details are not described herein again.

FIG. 10 is a schematic diagram of a structure of a repetition transmission apparatus 1000 according to an embodiment of this application. The apparatus 1000 includes: a sending module 1010, configured to send target indication information. The target indication information includes at least one of the following: first indication information, used to indicate a parameter related to performing uplink transmission beam refinement; second indication information, where the second indication information is used to indicate a transmission mode of an uplink transmission beam, and the transmission mode of the uplink transmission beam includes a first mode in which different uplink transmission beams are indicated to be used in a repetition transmission procedure of a target signal or a second mode in which a same uplink transmission beam is indicated to be used in a repetition transmission procedure of a target signal; or third indication information, where the third indication information is used to indicate a spatial relationship of an uplink transmission beam.

Optionally, the first indication information is used to indicate at least one of the following: a total number of different uplink transmission beams indicated to be used in the repetition transmission procedure corresponding to the target signal; an uplink transmission beam indicated to be used for each transmission in the repetition transmission procedure corresponding to the target signal; first uplink transmission beam group information, where the first uplink transmission beam group information is used to indicate the uplink transmission beam indicated to be used for each transmission in the repetition transmission procedure corresponding to the target signal; or second uplink transmission beam group information, where the second uplink transmission beam group information is used to indicate a set of uplink transmission beams indicated to be used in the repetition transmission procedure corresponding to the target signal.

Optionally, the second indication information includes at least one of the following: that the transmission mode of the uplink transmission beam is the first mode; that the transmission mode of the uplink transmission beam is the second mode; a number of repetition transmissions of the target signal; resource configuration information used for repetition transmission of the target signal; a first threshold, used to select a corresponding downlink reference signal in the transmission procedure of the target signal; a second threshold, where the second threshold is related to a measured value of a downlink path loss and used to determine the transmission mode of the uplink transmission beam; or a third threshold, where the third threshold is related to the number of repetition transmissions and used to determine the transmission mode of the uplink transmission beam.

Optionally, the third indication information is further used to indicate at least one of the following: validity duration of the spatial relationship of the uplink transmission beam; or a number of times of valid uplink sending corresponding to the spatial relationship of the uplink transmission beam.

The repetition transmission apparatus 1000 in the present embodiment of this application may be an electronic device, for example, an electronic device with an operating system, or may be a component in the electronic device, for example, an integrated circuit or a chip. The electronic device may be a network side device, or may be another device other than the network side device. For example, the network side device may include but is not limited to the foregoing listed types of the network side device 12, and the another device may be a server, a network attached storage (NAS), or the like. This is not limited in the present embodiment of this application.

The repetition transmission apparatus 1000 provided in the present embodiment of this application can implement the processes implemented in the method embodiment of FIG. 8, and achieve same technical effects. To avoid repetition, details are not described herein again.

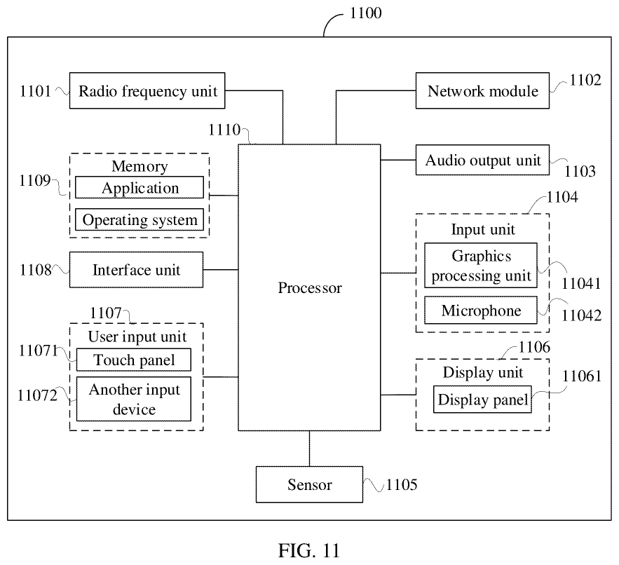

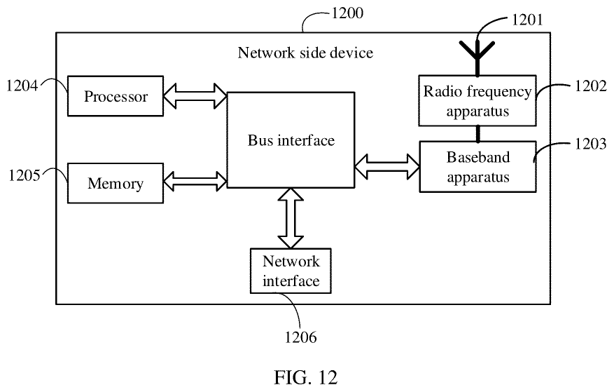

An embodiment of this application further provides a terminal, including a processor and a communication interface. The communication interface is coupled to the processor. The processor is configured to run a program or instructions to implement the steps in the method embodiments shown in FIG. 2 to FIG. 6. The terminal embodiment corresponds to the method embodiment on the terminal side, each implementation process and implementation of the method embodiment can be applied to the terminal embodiment, and a same technical effect can be achieved. For example, FIG. 11 is a schematic diagram of a hardware structure of a terminal according to an embodiment of this application.

The terminal 1100 includes but is not limited to at least a part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the terminal 1100 may further include a power supply (such as a battery) that supplies power to each component. The power supply may be logically connected to the processor 1110 by using a power supply management system, to implement functions such as charging and discharging management, and power consumption management by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that in the present embodiment of this application, the input unit 1104 may include a graphics processing unit (GPU) 11041 and a microphone 11042. The graphics processing unit 11041 processes image data of a static picture or a video obtained by an image capture apparatus 900 (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 or another input device 11072. The touch panel 11071 is also referred to as a touchscreen. The touch panel 11071 may include two parts: a touch detection apparatus 900 and a touch controller. The another input device 11072 may include but is not limited to a physical keyboard, a functional button (such as a volume control button or a power on/off button), a trackball, a mouse, and a joystick. Details are not described herein.

In the present embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may include a volatile memory and a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1109 in the present embodiment of this application includes but is not limited to these memories and any memory of another proper type.

The processor 1110 may include one or more processing units. Optionally, an application processor and a modem processor are integrated into the processor 1110. The application processor mainly processes an operating system, a user interface, an application, and the like. The modem processor mainly processes a wireless communication signal, for example, a baseband processor. It may be understood that, alternatively, the modem processor may not be integrated into the processor 1110.

The processor 1110 is configured to:
determine a target uplink transmission beam. The processor 1110 is configured to perform repetition transmission of a target signal based on the target uplink transmission beam. The target signal includes at least one of an Msg1, an Msg3, an MsgA, a CG-PUSCH, or an SRS.

Optionally, determining, by the processor 1110, the target uplink transmission beam includes: in a case that a first condition is met, performing at least one of the following: selecting a second downlink reference signal, and determining an uplink transmission beam that matches the second downlink reference signal as the target uplink transmission beam, where the second downlink reference signal is any of at least one first downlink reference signal associated with a first resource for repetition transmission; or determining an uplink transmission beam that matches a third downlink reference signal as the target uplink transmission beam, where the third downlink reference signal is associated with a second resource for repetition transmission, where the first resource for repetition transmission includes at least one of a resource for repetition transmission based on contention-free random access or a resource for small data transmission based on uplink grant, and the second resource for repetition transmission includes an SRS resource for repetition transmission used for inactive state positioning; and the first condition includes at least one of the following that: a measured value of the at least one first downlink reference signal associated with the first resource for repetition transmission is higher than a first threshold; or a timing advance TA used to send the SRS or the CG-PUSCH is valid.

Optionally, determining, by the processor 1110, the uplink transmission beam that matches the second downlink reference signal as the target uplink transmission beam includes at least one of the following: in a case that the second downlink reference signal is a synchronization signal block SSB, performing beam refinement based on the second downlink reference signal to obtain more than one matched uplink transmission beam, and determining the more than one matched uplink transmission beam obtained through beam refinement as the target uplink transmission beam; or in a case that the second downlink reference signal is a channel state information reference signal CSI-RS, determining the uplink transmission beam that matches the second downlink reference signal as the target uplink transmission beam.

Optionally, determining, by the processor 1110, the uplink transmission beam that matches the third downlink reference signal as the target uplink transmission beam includes: in a case that the third downlink reference signal is an SSB or a positioning reference signal PRS, performing beam refinement based on the third downlink reference signal to obtain more than one matched uplink transmission beam, and determining the more than one matched uplink transmission beam obtained through beam refinement as the target uplink transmission beam.

Optionally, determining, by the processor 1110, the more than one matched uplink transmission beam obtained through beam refinement as the target uplink transmission beam includes: determining, based on first indication information, the more than one matched uplink transmission beam obtained through beam refinement as the target uplink transmission beam, where the first indication information is used to indicate at least one of the following: a total number of different uplink transmission beams indicated to be used in the repetition transmission procedure corresponding to the target signal; an uplink transmission beam indicated to be used for each transmission in the repetition transmission procedure corresponding to the target signal; first uplink transmission beam group information, where the first uplink transmission beam group information is used to indicate the uplink transmission beam indicated to be used for each transmission in the repetition transmission procedure corresponding to the target signal; or second uplink transmission beam group information, where the second uplink transmission beam group information is used to indicate a set of uplink transmission beams indicated to be used in the repetition transmission procedure corresponding to the target signal.

Optionally, determining, by the processor 1110, the target uplink transmission beam includes: determining a transmission mode of an uplink transmission beam; and determining the target uplink transmission beam based on the transmission mode of the uplink transmission beam, where the transmission mode of the uplink transmission beam includes a first mode in which different uplink transmission beams are indicated to be used in the repetition transmission procedure of the target signal or a second mode in which a same uplink transmission beam is indicated to be used in the repetition transmission procedure of the target signal.

Optionally, determining, by the processor 1110, the transmission mode of the uplink transmission beam includes: in a case that a second condition is met, determining that the transmission mode of the uplink transmission beam is the first mode, where the second condition includes at least one of the following that: second indication information sent by a network side device is received, and the second indication information indicates that the transmission mode of the uplink transmission beam is the first mode; a measured value of a downlink path loss is less than a second threshold; repetition transmission of the target signal is performed based on the second mode, and transmission fails; or a number of repetition transmissions of the target signal is greater than or equal to a third threshold.

Optionally, before the processor 1110 determines the target uplink transmission beam based on the transmission mode of the uplink transmission beam, determining the target uplink transmission beam further includes: in a case that the second condition is not met, determining that the transmission mode of the uplink transmission beam is the second mode.

Optionally, the second indication information further includes or indicates at least one of the following: that the transmission mode of the uplink transmission beam is the second mode; the number of repetition transmissions of the target signal; resource configuration information used for repetition transmission of the target signal; the first threshold, used to select a corresponding downlink reference signal in the transmission procedure of the target signal; the second threshold, where the second threshold is related to a measured value of a downlink path loss and used to determine the transmission mode of the uplink transmission beam; or the third threshold, where the third threshold is related to the number of repetition transmissions and used to determine the transmission mode of the uplink transmission beam.

Optionally, in a case that the transmission mode of the uplink transmission beam is the first mode and the first condition is not met, determining, by the processor 1110, the target uplink transmission beam based on the transmission mode of the uplink transmission beam includes: selecting a fourth downlink reference signal, and determining an uplink transmission beam that matches the fourth downlink reference signal as the target uplink transmission beam, where the fourth downlink reference signal is any of at least one downlink reference signal associated with a third resource for repetition transmission, where the third resource for repetition transmission includes a resource for repetition transmission based on contention-based random access, repetition transmission of the target signal is applicable to a random access procedure, and the target signal includes at least one of the Msg1, the Msg3, or the MsgA.

Optionally, determining, by the processor 1110, the uplink transmission beam that matches the fourth downlink reference signal as the target uplink transmission beam includes: in a case that the fourth downlink reference signal is an SSB, performing beam refinement based on the fourth downlink reference signal to obtain more than one matched uplink transmission beam, and determining the more than one matched uplink transmission beam obtained through beam refinement as the target uplink transmission beam.

Optionally, in a case that the transmission mode of the uplink transmission beam is the second mode and the first condition is met, determining, by the processor 1110, the target uplink transmission beam based on the transmission mode of the uplink transmission beam includes at least one of the following: determining the uplink transmission beam that matches the second downlink reference signal as the target uplink transmission beam; or determining the uplink transmission beam that matches the third downlink reference signal as the target uplink transmission beam.

Optionally, the processor 1110 is further configured to: receive third indication information sent by the network side device, where the third indication information is used to indicate a spatial relationship of an uplink transmission beam; and perform, based on the spatial relationship of the uplink transmission beam, repetition transmission of the target signal using the target uplink transmission beam in a first time period, where the first time period is a time period between the terminal receives the third indication information and the terminal receives configuration information of the spatial relationship of the uplink transmission beam again.

Optionally, the third indication information is further used to indicate at least one of the following: validity duration of the spatial relationship of the uplink transmission beam; or a number of times of valid uplink sending corresponding to the spatial relationship of the uplink transmission beam.

Optionally, performing, by the processor 1110 based on the spatial relationship of the uplink transmission beam, sending using the target uplink beam in the first time period includes at least one of the following: within the validity duration or the number of times of valid uplink sending, sending the target signal using the target uplink transmission beam; or within the validity duration or the number of times of valid uplink sending, and in a case that a change amplitude of the measured value of the downlink path loss is less than a cell configuration threshold, sending the target signal based on the target uplink transmission beam.

Optionally, the spatial relationship of the uplink transmission beam is determined based on at least one of the following: an index value of a transmission occasion; an index value of a transmission; or a radio network temporary identifier RNTI associated with the transmission occasion.

Optionally, the processor 1110 is further configured to report terminal capability information to the network side device, where the terminal capability information is used to indicate that the terminal has a capability of scanning an uplink beam in the repetition transmission procedure of the target signal.

Optionally, content of the terminal capability information includes at least one of the following: a number of uplink transmission beams supported in the repetition transmission procedure; or uplink transmission beam refinement is supported in the repetition transmission procedure.

It may be understood that for an implementation process of each implementation in the present embodiment, reference may be made to related descriptions in the embodiments of the method 200 to the method 700, and same or corresponding technical effects can be achieved. To avoid repetition, details are not described herein again.

An embodiment of this application further provides a network side device, including a processor and a communication interface. The communication interface is coupled to the processor. The processor is configured to run a program or instructions to implement the steps in the method embodiment shown in FIG. 8. This network side device embodiment corresponds to the foregoing method embodiment of the network side device. Each implementation process and implementation of the foregoing method embodiment may be applicable to this network side device embodiment, and a same technical effect can be achieved.

For example, an embodiment of this application further provides a network side device. As shown in FIG. 12, the network side device 1200 includes an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information through the antenna 1201, and sends the received information to the baseband apparatus 1203 for processing. In a downlink direction, the baseband apparatus 1203 processes information that needs to be sent, and sends processed information to the radio frequency apparatus 1202. The radio frequency apparatus 1202 processes the received information, and sends processed information through the antenna 1201.

In the foregoing embodiment, the method performed by the network side device may be implemented in the baseband apparatus 1203. The baseband apparatus 1203 includes a baseband processor.

For example, the baseband apparatus 1203 may include at least one baseband board. A plurality of chips are disposed on the baseband board. As shown in FIG. 12, one chip is, for example, a baseband processor, and is connected to the memory 1205 by using a bus interface, to invoke a program in the memory 1205 to perform the operations of the network device shown in the foregoing method embodiment.

The network side device may further include a network interface 1206, and the interface is, for example, a common public radio interface (CPRI).

For example, the network side device 1200 in the present embodiment of the present application further includes instructions or a program that is stored in the memory 1205 and executable on the processor 1204. The processor 1204 invokes the instructions or the program in the memory 1205 to perform the method performed by the modules shown in FIG. 10, and a same technical effect is achieved. To avoid repetition, details are not described herein again.

An embodiment of this application further provides a non-transitory readable storage medium. The non-transitory readable storage medium stores a program or instructions. When the program or the instructions are executed by a processor, the processes of the embodiment of the repetition transmission method are implemented, and same technical effects can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface, and the communication interface is coupled to the processor. The processor is configured to run a program or instructions to implement the processes of the embodiment of the repetition transmission method, and same technical effects can be achieved. To avoid repetition, details are not described herein again.

It should be understood that the chip mentioned in the present embodiment of this application may also be referred to as a system-level chip, a system chip, a chip system, or a system on chip.

An embodiment of this application further provides a computer program/program product. The computer program/program product is stored in a non-transitory storage medium. The computer program/program product is executed by at least one processor to implement the processes in the embodiment of the repetition transmission method, and same technical effects can be achieved. To avoid repetition, details are not described herein again.

An embodiment of this application further provides a wireless communication system, including a terminal and a network side device. The terminal may be configured to perform the processes in the embodiments of the repetition transmission method 200 to the repetition transmission method 700, the network side device may be configured to perform the processes in the embodiment of the repetition transmission method 800, and same technical effects can be achieved. To avoid repetition, details are not described herein again.

It should be noted that the embodiments and implementations in this application may be applied to random access procedures including a two-step random access procedure and a four-step random access procedure, may also be applied to a small data transmission scenario, and may also be applied to other scenarios related to idle or inactive state transmission.

It should be noted that, in this specification, the term “include”, “comprise”, or any other variant thereof is intended to cover a non-exclusive inclusion, so that a process, a method, an article, or an apparatus 900 that includes a series of elements not only includes those elements but also includes other elements that are not expressly listed, or includes elements inherent to such a process, method, article, or apparatus 900. Without limitation, an element limited by the statement “includes a . . . ” does not exclude the existence of another same element in the process, method, article, or apparatus 900 in which the element is included. In addition, it should be noted that the scope of the method and the apparatus 900 in implementations of this application is not limited to performing functions in an illustrated or discussed sequence, and may further include performing functions in a basically simultaneous manner or in a reverse sequence according to the functions concerned. For example, the described method may be performed in a sequence different from that described, and steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or by using hardware. The computer software product is stored in a storage medium (such as a ROM, a RAM, a magnetic disk, or an optical disc), and includes several instructions for instructing a terminal or a network side device to perform the methods described in embodiments of this application.

Embodiments of this application are described above with reference to the accompanying drawings, but this application is not limited to the foregoing implementations, and the foregoing implementations are merely illustrative and not restrictive. Under the enlightenment of this application, a person of ordinary skill in the art can make many forms of implementations without departing from the purpose of this application and the protection scope of the claims, all of which fall within the protection scope of this application.

What is claimed is:

1. A repetition transmission method, comprising:
determining, by a terminal, a target uplink transmission beam; and
performing, by the terminal, repetition transmission of a target signal based on the target uplink transmission beam, wherein
the target signal comprises at least one of a message 1 (Msg1), a message 3 (Msg3), a message A (MsgA), a configured grant (CG)-physical uplink shared channel (PUSCH), or a sounding reference signal (SRS).

2. The method according to claim 1, wherein the determining a target uplink transmission beam comprises:
in a case that a first condition is met, performing at least one of the following:
selecting a second downlink reference signal, and determining an uplink transmission beam that matches the second downlink reference signal as the target uplink transmission beam, wherein the second downlink reference signal is any of at least one first downlink reference signal associated with a first resource for repetition transmission; or
determining an uplink transmission beam that matches a third downlink reference signal as the target uplink transmission beam, wherein the third downlink reference signal is associated with a second resource for repetition transmission, wherein
the first resource for repetition transmission comprises at least one of a resource for repetition transmission based on contention-free random access or a resource for small data transmission based on uplink grant, and the second resource for repetition transmission comprises an SRS resource for repetition transmission used for inactive state positioning; and
the first condition comprises at least one of the following that:
a measured value of the at least one first downlink reference signal associated with the first resource for repetition transmission is higher than a first threshold; or
a timing advance (TA) used to send the SRS or the CG-PUSCH is valid.

3. The method according to claim 2, wherein the determining an uplink transmission beam that matches the second downlink reference signal as the target uplink transmission beam comprises at least one of the following:
in a case that the second downlink reference signal is a synchronization signal block (SSB), performing beam refinement based on the second downlink reference signal to obtain more than one matched uplink transmission beam, and determining the more than one matched uplink transmission beam obtained through beam refinement as the target uplink transmission beam; or
in a case that the second downlink reference signal is a channel state information reference signal (CSI-RS), determining the uplink transmission beam that matches the second downlink reference signal as the target uplink transmission beam; or
the determining an uplink transmission beam that matches a third downlink reference signal as the target uplink transmission beam comprises:
in a case that the third downlink reference signal is a SSB or a positioning reference signal (PRS), performing beam refinement based on the third downlink reference signal to obtain more than one matched uplink transmission beam, and determining the more than one matched uplink transmission beam obtained through beam refinement as the target uplink transmission beam.

4. The method according to claim 2, wherein the determining the more than one matched uplink transmission beam obtained through beam refinement as the target uplink transmission beam comprises:
determining, based on first indication information, the more than one matched uplink transmission beam obtained through beam refinement as the target uplink transmission beam, wherein
the first indication information is used to indicate at least one of the following:
a total number of different uplink transmission beams indicated to be used in a repetition transmission procedure corresponding to the target signal;
an uplink transmission beam indicated to be used for each transmission in the repetition transmission procedure corresponding to the target signal;
first uplink transmission beam group information, wherein the first uplink transmission beam group information is used to indicate the uplink transmission beam indicated to be used for each transmission in the repetition transmission procedure corresponding to the target signal; or
second uplink transmission beam group information, wherein the second uplink transmission beam group information is used to indicate a set of uplink transmission beams indicated to be used in the repetition transmission procedure corresponding to the target signal.

5. The method according to claim 1, wherein the determining a target uplink transmission beam comprises:
determining a transmission mode of an uplink transmission beam; and
determining the target uplink transmission beam based on the transmission mode of the uplink transmission beam, wherein
the transmission mode of the uplink transmission beam comprises a first mode or a second mode, wherein the first mode indicates that different uplink transmission beams are indicated to be used in a repetition transmission procedure of the target signal, and the second mode indicates that a same uplink transmission beam is indicated to be used in the repetition transmission procedure of the target signal.

6. The method according to claim 5, wherein the determining a transmission mode of an uplink transmission beam comprises:
in a case that a second condition is met, determining that the transmission mode of the uplink transmission beam is the first mode, wherein
the second condition comprises at least one of the following that:
second indication information sent by a network side device is received, and the second indication information indicates that the transmission mode of the uplink transmission beam is the first mode;
a measured value of a downlink path loss is less than a second threshold;
the repetition transmission of the target signal is performed based on the second mode, and transmission fails; or
a number of repetition transmissions of the target signal is greater than or equal to a third threshold.

7. The method according to claim 6, wherein before the determining the target uplink transmission beam based on the transmission mode of the uplink transmission beam, the determining the target uplink transmission beam further comprises:
in a case that the second condition is not met, determining, by the terminal, that the transmission mode of the uplink transmission beam is the second mode.

8. The method according to claim 6, wherein the second indication information further comprises or indicates at least one of the following:
that the transmission mode of the uplink transmission beam is the second mode;
the number of repetition transmissions of the target signal;
resource configuration information used for the repetition transmission of the target signal;
a first threshold, used to select a corresponding downlink reference signal in the transmission procedure of the target signal;
the second threshold, wherein the second threshold is related to the measured value of the downlink path loss and used to determine the transmission mode of the uplink transmission beam; or
the third threshold, wherein the third threshold is related to the number of repetition transmissions and used to determine the transmission mode of the uplink transmission beam.

9. The method according to claim 5, wherein in a case that the transmission mode of the uplink transmission beam is the first mode and a first condition is not met, the determining the target uplink transmission beam based on the transmission mode of the uplink transmission beam comprises:
selecting a fourth downlink reference signal, and determining an uplink transmission beam that matches the fourth downlink reference signal as the target uplink transmission beam, wherein the fourth downlink reference signal is any of at least one downlink reference signal associated with a third resource for repetition transmission, wherein
the third resource for repetition transmission comprises a resource for repetition transmission based on contention-based random access, the repetition transmission of the target signal is applicable to a random access procedure, and the target signal comprises at least one of the Msg1, the Msg3, or the MsgA.

10. The method according to claim 9, wherein the determining an uplink transmission beam that matches the fourth downlink reference signal as the target uplink transmission beam comprises:
in a case that the fourth downlink reference signal is a synchronization signal block (SSB), performing beam refinement based on the fourth downlink reference signal to obtain more than one matched uplink transmission beam, and determining the more than one matched uplink transmission beam obtained through beam refinement as the target uplink transmission beam.

11. The method according to claim 5, wherein in a case that the transmission mode of the uplink transmission beam is the second mode and a first condition is met, the determining the target uplink transmission beam based on the transmission mode of the uplink transmission beam comprises at least one of the following:
determining the uplink transmission beam that matches a second downlink reference signal as the target uplink transmission beam; or
determining the uplink transmission beam that matches a third downlink reference signal as the target uplink transmission beam.

12. The method according to claim 1, wherein after the performing, by the terminal, repetition transmission of a target signal based on the target uplink transmission beam, the method further comprises:
receiving third indication information sent by a network side device, wherein the third indication information is used to indicate a spatial relationship of an uplink transmission beam; and
performing, by the terminal based on the spatial relationship of the uplink transmission beam, the repetition transmission of the target signal using the target uplink transmission beam in a first time period, wherein
the first time period is a time period between the terminal receives the third indication information and the terminal receives configuration information of the spatial relationship of the uplink transmission beam again.

13. The method according to claim 12, wherein the third indication information is further used to indicate at least one of the following:
validity duration of the spatial relationship of the uplink transmission beam; or
a number of times of valid uplink sending corresponding to the spatial relationship of the uplink transmission beam.

14. The method according to claim 13, wherein performing, based on the spatial relationship of the uplink transmission beam, sending using the target uplink beam in the first time period comprises at least one of the following:
within the validity duration or the number of times of valid uplink sending, sending, by the terminal, the target signal using the target uplink transmission beam; or
within the validity duration or the number of times of valid uplink sending, and in a case that a change amplitude of a measured value of a downlink path loss is less than a cell configuration threshold, sending, by the terminal, the target signal based on the target uplink transmission beam.

15. The method according to claim 12, wherein the spatial relationship of the uplink transmission beam is determined based on at least one of the following:
an index value of a transmission occasion;
an index value of a transmission; or
a radio network temporary identifier (RNTI) associated with the transmission occasion.

16. The method according to claim 1, wherein the method further comprises:
reporting, by the terminal, terminal capability information to a network side device, wherein the terminal capability information is used to indicate that the terminal has a capability of scanning an uplink beam in a repetition transmission procedure of the target signal;
wherein content of the terminal capability information comprises at least one of the following:
a number of uplink transmission beams supported in the repetition transmission procedure; or
uplink transmission beam refinement is supported in the repetition transmission procedure.

17. A repetition transmission method, comprising:
sending, by a network side device, target indication information, wherein
the target indication information comprises at least one of the following:
first indication information, used to indicate a parameter related to performing uplink transmission beam refinement;
second indication information, wherein the second indication information is used to indicate a transmission mode of an uplink transmission beam, and the transmission mode of the uplink transmission beam comprises a first mode in which different uplink transmission beams are indicated to be used in a repetition transmission procedure of a target signal or a second mode in which a same uplink transmission beam is indicated to be used in a repetition transmission procedure of a target signal; and
third indication information, wherein the third indication information is used to indicate a spatial relationship of an uplink transmission beam.

18. The method according to claim 17, wherein the first indication information is used to indicate at least one of the following:
a total number of different uplink transmission beams indicated to be used in the repetition transmission procedure corresponding to the target signal;
an uplink transmission beam indicated to be used for each transmission in the repetition transmission procedure corresponding to the target signal;
first uplink transmission beam group information, wherein the first uplink transmission beam group information is used to indicate the uplink transmission beam indicated to be used for each transmission in the repetition transmission procedure corresponding to the target signal; and
second uplink transmission beam group information, wherein the second uplink transmission beam group information is used to indicate a set of uplink transmission beams indicated to be used in the repetition transmission procedure corresponding to the target signal.

19. A terminal, comprising a processor and a memory, wherein the memory stores a program or instructions executable on the processor; and the program or the instructions, when executed by the processor, cause the terminal to perform:
determining a target uplink transmission beam; and
performing repetition transmission of a target signal based on the target uplink transmission beam, wherein
the target signal comprises at least one of a message 1 (Msg1), a message 3 (Msg3), a message A (MsgA), a configured grant (CG)-physical uplink shared channel (PUSCH), or a sounding reference signal (SRS).

20. A network side device, comprising a processor and a memory, wherein the memory stores a program or instructions executable on the processor; and when the program or the instructions are executed by the processor, the steps of the repetition transmission method according to claim 17 are implemented.
